(19) United States
(12) Patent Application Publication
(10) Pub. No.: US 2007/0273971 A1
(43) Pub. Date: Nov. 29, 2007

(54) Cleaning Assembly for Motor Vehicle

(76) Inventors: Bernd Waldmann, Nurtingen (DE); Klaus Weller, Ebersbach (DE); Karl-Heinz Leonberger, Hochdorf (DE)

Correspondence Address: REISING, ETHINGTON, BARNES, KISSELLE, P.C., P O BOX 4390, TROY, MI, 48099-4390, US

(21) Appl. No.: 10/575,674

(22) PCT Filed: Oct. 7, 2004
(86) PCT No.: PCT/DE04/02233

§ 371 Date: Apr. 3, 2007

(30) Foreign Application Priority Data
Oct. 14, 2003 (DE) 103 48 885.5

(51) Int. Cl. B60S 1/52

(52) U.S. Cl. 359/509

(57) ABSTRACT

A cleaning assembly cleans an exterior surface of a motor vehicle. The exterior surface defines first and second edges. The motor vehicle includes a cleaning fluid reservoir. The cleaning assembly includes a connector for connecting the cleaning fluid reservoir with the cleaning assembly for receiving fluid therefrom. A distribution chamber is in fluid communication with the connector and receives the fluid received by the connector. The cleaning assembly also includes a nozzle fixedly secured to the distribution chamber for disbursing the fluid over the exterior surface. The nozzle includes a nozzle opening that defines a slot opening such that a film of fluid exits the nozzle opening over the exterior surface.

### BACKGROUND ART

1. Field of the Invention

The invention relates to a cleaning device for a motor vehicle. More particularly, the invention relates to a cleaning device for an exterior surface of a portion of a motor vehicle.

2. Description of the Related Art

In the use of ultra-hydrophobic coatings, the water automatically rolls off the coated surface, thereby entraining dirt particles. However, if only moist dirt particles are present on the coated surface, even with ultra-hydrophobic coatings, the dirt particles may not run off, but instead may remain adherent. Such ultra-hydrophobic coatings are used for mirror glass in exterior rearview mirrors of motor vehicles, for headlights, tail lights, or camera lenses, or to cover same, or for windshields or rear windows, as well as auxiliary brake lights. It is not possible to achieve an adequate cleaning action for these parts of the motor vehicle. These disadvantages are present not only for hydrophobic coatings, but also for conventional surfaces.

### SUMMARY OF THE INVENTION

A cleaning assembly cleans an exterior surface of a motor vehicle. The exterior surface defines first and second edges. The motor vehicle includes a cleaning fluid reservoir. The cleaning assembly includes a connector for connecting the cleaning fluid reservoir with the cleaning assembly for receiving fluid therefrom. A distribution chamber is in fluid communication with the connector and receives the fluid received by the connector. The cleaning assembly also includes a nozzle fixedly secured to the distribution chamber for disbursing the fluid over the exterior surface. The nozzle includes a nozzle opening that defines a slot opening such that a film of fluid exits the nozzle opening over the exterior surface.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a front view of a portion of an external rearview mirror of a motor vehicle incorporating one embodiment of the invention;

FIG. 2 is a front view of a portion of an external rearview mirror of a motor vehicle incorporating a second embodiment of the invention;

FIG. 3 is a cross-sectional side view taken along lines III-III of FIG. 1;

FIG. 4 is a detailed view of area IV of FIG. 3;

FIG. 5 is top view of the external mirror taken along arrow V of FIG. 1; and

FIG. 6 is a cross-sectional side view of a third embodiment of the invention.

### DETAILED DESCRIPTION OF THE PREFERRED EMBODIMENTS

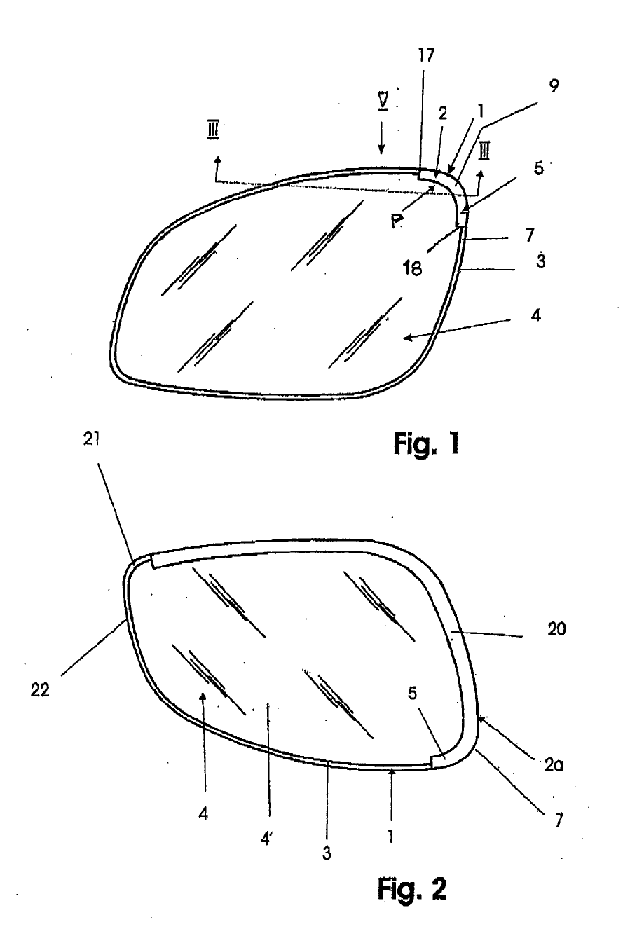

FIG. 1 shows a portion of an external rearview mirror 1 having a cleaning device 2 provided in a corner region of a mirror glass holder 3. The mirror glass holder supports in a known manner a mirror glass 4 having a hydrophobic coating. The mirror glass holder 3 is accommodated in a mirror housing (not illustrated) which is attached to the vehicle by a mirror mounting bracket. The mirror housing is able to swivel with respect to the mirror mounting bracket in both the direction of travel of the vehicle and the opposite direction thereto. For the two swivel directions, one swivel axis may be provided for each direction (double-axis mirror), or only one swivel axis (single-axis mirror) may be provided. It is advantageous for the mirror head to be able to swivel in the parked position as well.

The mirror head may accommodate heating devices for heating the mirror glass 4 for a nozzle 5, to be described below, in the cleaning device 2, at least one ambient light, a repeating directional indicator light, at least one speaker, a GPS module, a drive for the motorized adjustment of the mirror glass holder 3, an antenna, a camera, and the like. These built-in elements may be provided in any given combination or also singly, depending on the requirements of the vehicle manufacturer.

An ambient light, a speaker, and the like may be housed in the mirror mounting bracket. These built-in elements as well may be provided singly or in any given combination.

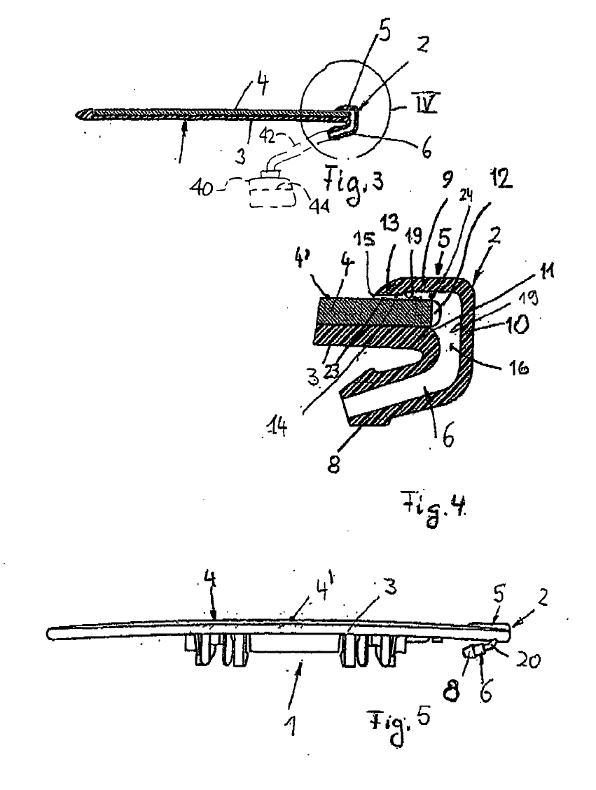

The cleaning device 2 has a nozzle 5 and a connector 6 for a cleaning medium. 44, preferably water. The connector 6 is connected to a supply container 40 for the cleaning medium 44 via a line 42 (both schematically shown in FIG. 3). The supply container 40 may be the container for the window and/or headlight washing system. However, a separate supply container may also be provided which is installed at a suitable location in the vehicle.

The cleaning medium 44, which is to be applied to the mirror glass 4 to be cleaned via the cleaning device 2, is supplied under pressure from the supply container 40 to the connector 6 by means of a pump (not illustrated) using or through a controllable multi-way valve. The nozzle 5 and the connector 6 together with the mirror glass holder 3 may be manufactured in one piece from an appropriate plastic. The connector 6 is situated behind the mirror glass holder 3, thus enabling the line 42 for supplying the cleaning medium 44 to be connected in a concealed manner. To ensure a secure seating for the line 44, the free end 8 of the connector 6 has a conically expanded design in the direction of insertion of the line 44 in a manner known in the art.

In the embodiment according to FIG. 1, the nozzle 5 for the cleaning device 2 is situated in the corner region of the mirror glass 4. The nozzle 5 extends over an angular region of approximately 90°, and with its wall 9 overlaps the mirror glass 4. According to FIG. 1, the nozzle 5 is curved with respect to the mirror edge on which it is provided. The wall 9 runs parallel to and at a small distance from the top side 4′ of the mirror glass 4, and makes a right-angle transition to a side wall 10, which, in turn, perpendicularly adjoins the edge 11 of the mirror glass holder 3. The side wall 10 is separated by a distance from the edge 12 of the mirror glass 4. The walls 9 and 10 of the cleaning device 2 extend over an angular range of approximately 90°.

The exposed edge 13 of the wall 9 is slightly curved in the direction of the mirror glass 4, and has a flat end face 14 which is parallel to the top side 4′ of the mirror glass 4 and together with same forms an oblong channel 23 which extends over an angular range of approximately 90°. The depth of the channel is approximately a multiple larger than the height thereof. The end-face channel opening forms a narrow, essentially rectangular nozzle opening 15 through which the cleaning medium 44 emerges from the nozzle 5 under sufficiently high pressure. Since the nozzle opening 15 extends over an angular range, the cleaning medium 44 emerges not in the form of a jet, but instead as a flat film of liquid, whereby the dirt particles on the surface 4′ of the mirror glass 4 are impinged on by the cleaning medium 44 over the entire surface to be cleaned, and are outwardly swept away to the edges of the mirror by the nozzle 5. Optimum cleaning of the mirror glass is thereby achieved in a simple manner. The distance between the end face 14 and the top side 4′ of the mirror glass is a multiple smaller than the depth of the channel 23, but is significantly less than the length of the nozzle edge 9 or the nozzle opening 15. In the front view (arrow P in FIG. 1), the channel 23 has a rectangular contour and advantageously extends over the entire circumferential region of the nozzle 5.

As a result of the design according to the invention, the cleaning medium 44 emerges as a flat film of liquid which impinges over the surface to be cleaned as soon as it emerges from the outlet opening. The outlet opening may be very narrow, so that the cleaning medium 44 strikes the surface to be cleaned at a high velocity and reliably removes even stubborn, deep-seated dirt. The oblong channel 23 allows the cleaning medium 44 to be supplied uniformly to the outlet opening. The emerging flat film of liquid sweeps away the dirt particles on the surface to be cleaned, thereby reliably removing even strongly adhering particles.

The cleaning medium 44 supplied via the connector 6 first passes into a distribution chamber 16 which is externally bordered by the walls 9, 10 of the nozzle 5 and is internally bordered by the edges 11, 12 of the mirror glass 4 and the mirror glass holder 3. As shown in FIG. 1, the distribution chamber 16 is bordered on its end face region by end walls 17, 18 which are designed as one piece together with the walls 9, 10 and the mirror glass holder 3, and which form the side boundaries of the channel 23.

Since the visible side 4′ of the mirror glass 4 is adjacent to the channel 23 and the nozzle opening 15 on one side, the cleaning medium 44 reaches the mirror glass 4 directly. Even the surface portion of the mirror glass 4 beneath the wall 9 is easily impacted by the cleaning medium 44.

Adjoining the end face 14 or the channel 23, the interior 19 of the distribution chamber 16 is outwardly offset, thereby forming a step and a contiguous expanded space 24 which is part of a distribution chamber 16. The oblong channel 23 is thinner in cross section than the distribution chamber 16. However, in the direction transverse to the direction of flow of the cleaning medium 44 the space 24 has a smaller extension than the remainder of the distribution chamber 16 (FIG. 4). This assists in effective cleaning, since the flow velocity of the cleaning medium 44 is increased as a result of the cross-sectional constriction upstream from the nozzle opening 15 or upstream from the channel 23.

In principle, the cleaning device 2 may be provided at any of the corners of the mirror glass 4. It is also possible to provide one cleaning device 2 at each of two, three, or all four corners of the mirror glass 4.

A second embodiment according to FIG. 2 differs from the previous exemplary embodiment in that the cleaning device 2a extends over a considerably greater length. The cleaning device runs from the corner region 7 over the outer side edge 20 and the upper longitudinal edge 21, almost to the inner side edge 22 of the mirror glass 4. For supplying the cleaning medium 44 the connector is provided at a suitable location on the cleaning device 2a, and in other respects has the same design as in the previous exemplary embodiment.

Such a long cleaning device 2, 2a may be divided into two or more chambers, each of which is associated with a connection. The cleaning medium 44 then emerges from each of the nozzle openings in the chambers in a flat manner, so that the mirror glass 4 is impinged on over its entire surface and dirt particles thereon are swept away.

The cleaning device 2, 2a may also be provided on the mirror mounting bracket (not illustrated) for the external rearview mirror. The cleaning device is positioned so that the cleaning medium 44 strikes the side window of the motor vehicle. The nozzle opening once again has a slotted shape so that the cleaning medium 44 emerges as a flat film of liquid.

As shown in FIG. 6, a third embodiment of the cleaning device 2b may also be a separate unit or a built-in module which is attached at the mounting location, for example by gluing, clipping, plugging in, or the like. In this case, the glass support plate 3b is attached by its angled edge 25 in a groove 26 in the device 2b. The groove 26 is situated in a relatively thick-walled transitional segment 27 between the nozzle 5b and the water connector 6b, which has essentially the same design as in FIG. 1. In contrast to the two previous exemplary embodiments, the channel 23b is bordered by two flat, parallel end faces 14b and 28 which are a component of the nozzle 5b. The end face 28 of the channel 23b lies in the same plane as the top side 4′ of the mirror glass 4. As soon as the cleaning medium 44 emerges from the slot-shaped nozzle opening 15b, it reaches the top side 4′ of the mirror glass. Because of the slot-shaped design, as in the previous embodiments the cleaning liquid emerges as a thin film of liquid over the length of the nozzle opening 15b.

The end face 28 and the top side 4′ of the mirror glass directly adjoin one another, so that the cleaning medium 44 reaches the top side 4′ of the mirror glass without difficulty. To achieve a clean connection of the end face 28 of the nozzle 5b to the top side 4′ of the mirror glass, the end face adjoins a connecting side 29 of the nozzle 5b at an acute angle.

The same as for the previous embodiments, the flat film of liquid sweeps away the dirt particles on the top side 4′ of the mirror glass, so that even firmly adhering particles are reliably dislodged.

The space 24b, which is at a higher level than the channel 23b, adjoins the channel 23b and has the same design as in the previous exemplary embodiments.

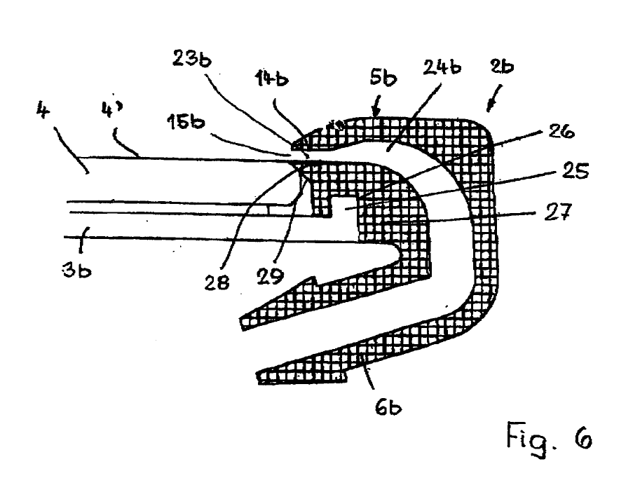

The nozzle 5b in other respects has the same design as the nozzles described according to FIGS. 1 through 5. The cleaning device 2b may extend over an angular range of 90°, for example, according to FIG. 1. However, the cleaning device 2b may also extend over a longer edge region of the mirror glass 4, as described by way of example with reference to FIG. 2.

The cleaning device 2, 2a, 2b may also be provided as an integrated or separated component of the headlights, tail lights, camera lenses, windshield, back window, or auxiliary brake lights of vehicles. Of course, multiple cleaning devices may be provided on the vehicle to clean various parts thereof.

The pump or the multi-way valve may be manually switched on and off. It is also possible to actuate the pump or the multi-way valve by means of the signal from a sensor which measures the degree of soiling on the surface to be cleaned and emits a switching signal when a specified degree of soiling is exceeded. In this manner the surface is automatically cleaned.

The surfaces to be cleaned may be provided with a hydrophobic or ultra-hydrophobic coating. However, the cleaning device 2, 2a, 2b may also be used for surfaces which do not have such a coating.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1-18. (canceled)

19. A cleaning assembly for cleaning an exterior surface, having first and second edges, of a motor vehicle, having a cleaning fluid reservoir, said cleaning assembly comprising:
a connector for connecting the cleaning fluid reservoir with said cleaning assembly for receiving fluid therefrom;
a distribution chamber in fluid communication with said connector for receiving the fluid received by said connector; and
a nozzle fixedly secured to said distribution chamber for disbursing the fluid over the exterior surface, said nozzle including a nozzle opening defining a slot opening such that a film of fluid exits said nozzle opening over the exterior surface.

20. A cleaning assembly as set forth in claim 19 wherein said nozzle opening includes an oblong channel for receiving a portion of one of the first and second edges therein.

21. A cleaning assembly as set forth in claim 20 wherein said distribution channel is generally perpendicular to said nozzle opening.

22. A cleaning assembly as set forth in claim 21 wherein said nozzle opening extends over portions of said first and second edges.

23. A cleaning assembly as set forth in claim 22 wherein said oblong channel defines a depth and a height wherein said depth is a multiple larger than said height.

24. A cleaning assembly as set forth in claim 23 wherein said oblong channel defines a cross section that is constant thereacross.

25. A cleaning assembly as set forth in claim 24 including a holder for holding the exterior surface in a position relative to said nozzle.

26. A cleaning assembly as set forth in claim 25 wherein said cleaning assembly defines a C-shaped cross section.

27. A cleaning assembly as set forth in claim 24 including a groove for receiving a portion of the exterior surface therein to accurately position said cleaning assembly with respect to the exterior surface.

28. A cleaning assembly as set forth in claim 27 wherein said depth of said nozzle opening is smaller than a depth of said distribution channel.
